(19) United States
(12) Patent Application Publication
(10) Pub. No.: US 2013/0288843 A1
(43) Pub. Date: Oct. 31, 2013

(54) MACHINE SYSTEM HAVING A LUBRICATION SYSTEM

(71) Applicants: Jochen Baum, Gochsheim/Weyer (DE); Jens Demtröder, Ronde (DK); Ralf Rüschoff, Datteln (DE)

(72) Inventors: Jochen Baum, Gochsheim/Weyer (DE); Jens Demtröder, Ronde (DK); Ralf Rüschoff, Datteln (DE)

(73) Assignee: VESTAS WIND SYSTEMS A/S, Aarhus N (DK)

(21) Appl. No.: 13/878,709

(22) PCT Filed: Oct. 17, 2011
(86) PCT No.: PCT/EP2011/068064

§ 371 Date: Jul. 8, 2013

Related U.S. Application Data
(60) Provisional application No. 61/393,387, filed on Oct. 15, 2010.
(60) Provisional application No. 61/441,763, filed on Feb. 11, 2011.

(30) Foreign Application Priority Data
Feb. 11, 2011 (DK) PA 201170080

(51) Int. Cl. F16H 57/04; F01M 5/00

(52) U.S. Cl. CPC F16H 57/0413; F01M 5/00; F16H 57/0436
USPC 475/160; 184/14; 184/104.1; 184/26

(57) ABSTRACT

The present invention relates to a machine system comprising a machine having at least a first section and a second section, the first section having a first velocity and the second section having a second velocity, the second velocity being different from the first velocity, and a lubrication system comprising at least one tank having one lubricant, the lubrication system being connected to the first and second sections. Furthermore, the invention relates to a wind turbine comprising the machine system.

### FIELD OF THE INVENTION

The present invention relates to a machine system comprising a machine having at least a first section and a second section, the first section having a first velocity and the second section having a second velocity, the second velocity being different from the first velocity, and a lubrication system comprising at least one tank having one lubricant, the lubrication system being connected to the first and second sections. Furthermore, the invention relates to a wind turbine comprising the machine system.

The present invention also relates to a method for lubricating a machine system.

### BACKGROUND ART

Machines having different moving parts need to be lubricated in order to function properly. Gearbox systems used for instance in connection with wind turbines are usually lubricated by one or more lubricants supplied to the different lubrication points at substantially the same temperature.

With a typical gear ratio of >100 (and up to 150 in a large offshore wind turbine), there is a substantial variation in velocities across the different gear and bearing contacts in one single gearbox. The ability of a contact to build a separating and load carrying lubrication film decreases with lower speeds, as described by the EHL theory.

Therefore, high base lubricant viscosities and low oil temperatures are typically chosen to secure sufficient lubrication for the high loaded slow-speed stages of the gearboxes. The high-speed stages in the gearbox will build sufficient lubrication films, even with lower viscosity (due to the higher velocity). In these stages, the thick oils required for the low-speed stages increase power losses in the high-speed parts of the gearbox due to churning and compression. This may cause overheating of these components. In addition, cooling all the lubrication volume to a temperature lower than needed increases the cost and energy consumption in the cooling system.

### SUMMARY OF THE INVENTION

It is an object of the present invention to wholly or partly overcome the above disadvantages and drawbacks of the prior art. More specifically, it is an object to provide a machine system having an improved lubrication system.

The above objects, together with numerous other objects, advantages, and features, which will become evident from the below description, are accomplished by a solution in accordance with the present invention by a machine system comprising
a machine having at least a first section and a second section, the first section having a first velocity and the second section having a second velocity, the second velocity being different from the first velocity,
a lubrication system comprising at least one tank having one lubricant, the lubrication system being connected to the first and second sections, wherein at least one property of the lubricant is changed before the lubricant is introduced into at least one of the sections.

In this way, a property of the lubricant may be changed based on the demand of a specific section so that the property of the lubricant being introduced into a section is appropriate for that specific section based on its velocity. Thus, introducing a lubricant having the required property allows for optimal lubrication between the contact surfaces of the moving parts inside a section. Hence, a lower power loss of the machine is obtained, and the appropriate property of the lubrication may prolong the service lives of the different moving parts inside the section.

In an embodiment, the property of the lubricant may be a temperature and/or a viscosity, which is a simple and reliable way to control the property of a lubricant.

Furthermore, the tank may comprise a heat exchanger. Hereby, the lubricant may be maintained at a temperature allowing potential oxidation of the lubricant to be kept at a minimum, thereby prolonging the life time of the lubricant.

Furthermore, considering the fact that the lubricant used in machines is most often an oil composition, oil is a chemical which consumes fossil resources and is difficult to recycle in an environmentally friendly way. It is therefore an advantage to use the lubricant for as long as possible. Also, a prolonged lubricant service life reduces service needs and increases component reliability.

Moreover, the machine may comprise a plurality of sections, each having a velocity which is different from the velocities of the other sections.

Additionally, at least one heat exchanger may be arranged between the tank and the machine for changing the temperature of the lubricant before it is introduced into a section of the machine. This provides for a simple and efficient way to control the temperature, and thereby the viscosity, of the lubricant before it is introduced into a specific section, thereby enabling optimal lubrication of the section.

Also, a heat transfer system may be arranged in connection with each section.

In addition, the lubricant may be led back into the tank after having been in a section of the machine. When one lubricant is being used, it is possible to lead that lubricant back into the tank and mix it with lubricants from other sections. This makes it possible to use the inherent heat, i.e. the temperature of the lubricant at the outlet of a section, for heating or cooling a lubricant from another section, thereby obtaining a desired temperature of the lubricant in the tank using a minimum of energy.

Furthermore, the lubricant may be oil.

In an embodiment, the sections of the machine may have at least partially fluid-tight separations. This prevents an incorrect lubrication temperature and/or viscosity from being led between two adjacent sections. Avoiding an incorrect temperature and/or viscosity of a lubricant accidentally being led between two adjacent sections, allows for optimal lubrication between the contact surfaces of the moving parts inside a section.

Furthermore, the temperature of the lubricant present in the tank may be maintained above a predetermined level. The predetermined level may be between 0 degree Celsius and 70 degree Celsius, preferably between 0 degree Celsius and 30 degree Celsius. Advantageously, the temperature of the lubricant is kept below 70 degrees Celsius, whereby oxidation of the lubricant is avoided, which prolongs the life time of the lubricant.

Moreover, the temperature/viscosity of the lubricant introduced into the first section may be between 30 degrees Celsius and 50 degrees Celsius.

In addition, the temperature/viscosity of the lubricant introduced into the second section may be between 50 degrees Celsius and 80 degrees Celsius.

In an embodiment, the machine may be a gearbox. The present invention is especially advantageously in connection with a gearbox, since a gearbox has several sections with different velocities.

Moreover, the first section and/or the second section may comprise a plurality of stages, each stage having individual stage velocities.

The stage velocities comprised in the same section may be substantially identical to or different from each other.

Additionally, the sections and/or stages may comprise movable gear parts and/or bearings.

Furthermore, the gearbox may have planetary gear stages, be a planetary coupled gearbox or be a differential gearbox.

Moreover, an inlet flow of lubricant to a first section may be different from an inlet flow of lubricant to a second section.

In addition, the lubrication system may comprise pressure sensors adapted to measure a pressure of the lubricant, at least at an inlet to the sections.

Moreover, the pressure sensors may be connected to a control unit which is adapted to control a pump to ensure that a flow, and thereby the pressure, of the lubricant has a predetermined level before the lubricant is introduced into a specific section.

Furthermore, a flow of lubricant may be the same for all sections or vary from section to section.

The lubrication system may comprise temperature sensors adapted to measure a temperature of the lubricant, at least at an inlet to the sections.

Furthermore, the temperature sensors may be connected to a control unit which is adapted to control the heat exchanger to ensure that the temperature of the lubricant has a predetermined level before the lubricant is introduced into a specific section.

In addition, the lubricant may be led from a first section to another section.

Also, the lubricant may be led from the first section into the second section through a heat exchanger.

Additionally, a heating element may be arranged in the lubrication system for heating the lubricant directly

Moreover, each heat exchanger may have its own circulating heat transfer medium.

Furthermore, the heat exchangers may share circulating a heat transfer medium.

In addition, the heat exchangers of the lubrication system may share heat transfer media with heat exchangers of neighbouring consumer systems.

Also, the viscosity of the lubricant in the second section may be lower than that in the first section, or vice versa.

Moreover, the lubrication system may comprise a plurality of tanks.

The present invention furthermore relates to a wind turbine comprising the machine system described above.

The machine system of the wind turbine may be a gearbox system.

The present invention also relates to a method for lubricating a machine system, the machine system comprising
a machine having at least a first section and a second section, the first section having a first velocity and the second section having a second velocity, the second velocity being different from the first velocity,
a lubrication system comprising at least one tank having one lubricant, the lubrication system being connected to the first and second sections, wherein the method comprises the step of changing at least one property of the lubricant before the lubricant is introduced into at least one of the sections.

Furthermore, the property of the lubricant may be a temperature and/or a viscosity.

Moreover, a temperature of the lubricant may be changed before it is introduced into a section of the machine by means of at least one heat exchanger arranged between the tank and the machine.

In addition, the lubricant may be led back into the tank after having been in a section of the machine.

Furthermore, the temperature of the lubricant present in the tank may be maintained above a predetermined level.

The predetermined level is between 0 degrees Celsius and 70 degrees Celsius, preferably between 0 degrees Celsius and 30 degrees Celsius.

Also, the temperature/viscosity of the lubricant introduced into the first section may be between 30 degrees Celsius and 50 degrees Celsius.

Moreover, the temperature/viscosity of the lubricant introduced into the second section may be between 50 degrees Celsius and 80 degrees Celsius.

Additionally, a pressure of the lubricant may be measured by a pressure sensors, at least at an inlet to the sections.

Also, the pressure sensors are connected to a control unit which is adapted to control a pump to ensure that a flow, and thereby the pressure, of the lubricant has a predetermined level before the lubricant is introduced into a specific section.

Furthermore, an inlet flow of lubricant to a first section may be different from an inlet flow of lubricant to a second section.

Moreover, a temperature of the lubricant may be measured by temperature sensors, at least at an inlet to the sections.

The temperature sensors are connected to a control unit which is adapted to control the heat exchanger to ensure that the temperature of the lubricant has a predetermined level before the lubricant is introduced into a specific section.

### BRIEF DESCRIPTION OF THE DRAWINGS

The invention and its many advantages will be described in more detail below with reference to the accompanying schematic drawings, which for the purpose of illustration show some non-limiting embodiments and in which

FIG. 1 shows an embodiment of a machine system according to the present invention,

FIG. 2 shows another embodiment of a machine system according to the present invention,

FIG. 3 shows yet another embodiment of a machine system according to the present invention,

FIG. 4 shows one more embodiment of a machine system according to the present invention,

FIG. 5 shows a further embodiment of a machine system according to the present invention, and

FIG. 6 shows an additional embodiment of a machine system according to the present invention.

All the figures are highly schematic and not necessarily to scale, and they show only those parts which are necessary in order to elucidate the invention, other parts being omitted or merely suggested.

### DETAILED DESCRIPTION OF THE INVENTION

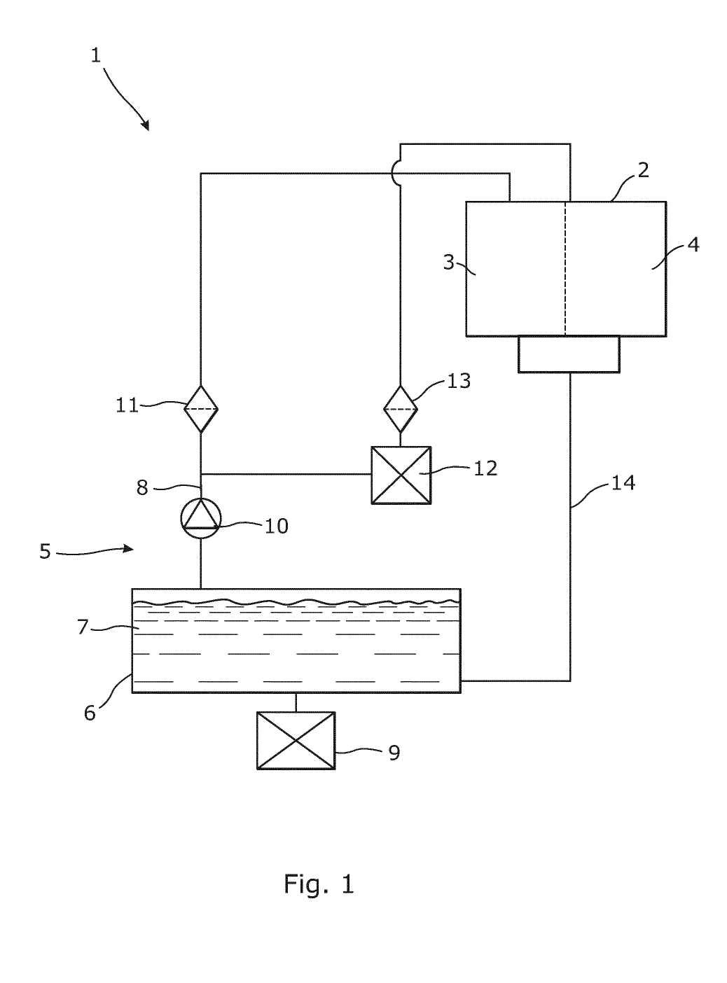

FIG. 1 shows a schematic diagram of a machine system 1 having a lubrication system according to the present invention.

The machine system 1 comprises a machine 2 having at least a first section 3 and a second section 4. The first section 3 has a first velocity, i.e. different machine components having working speeds/velocities, and the second section 4 has a second velocity, i.e. different machine components having working speeds/velocities. The second velocity is different from the first velocity. In FIG. 1, the two sections 3, 4 are separated by a dotted line.

Furthermore, a lubrication system 5 is arranged in connection with the machine system 1. In the embodiment shown in FIG. 1, the lubrication system 5 comprises one tank 6 having one lubricant 7, and the lubrication system 5 is connected to the first and second sections 3, 4 via a conduit system 8.

In connection with the tank 6, a heat exchanger 9 is arranged for changing the temperature of the lubricant 7 in the tank 6 to a predetermined temperature. Thus, the heat exchanger 9 may cool or heat the lubricant 7 as required. In the embodiment shown in FIG. 1, the heat exchanger 9 is arranged outside the tank 6, however, heat transfer elements (not shown) of the heat exchanger are arranged inside the tank 6. The heat exchanger 9 secures that the lubricant 7 in the tank 6 has a predetermined property, for instance a viscosity or temperature.

The lubricant 7 is led from the tank 6 to the machine 2 by means of a pump 10.

The pump 10 secures a constant or variable flow of lubricant 7 to the machine 2. Before the lubricant 7 is introduced into the first section 3 of the machine 2, it passes a filter 11 filtering the lubricant 7. In this embodiment, a part of the lubricant 7 is branched off after passing the pump 10, and this part is led through an additional heat exchanger 12 which is adapted to change the temperature of the lubricant 7 before it is introduced into the second section 4 via an additional filter 13. Hereby, the property of the branched-off lubricant 7 is changed before being introduced into the second section 4, and is thereby different from the property of the lubricant 7 introduced into the first section 3. Thus, the lubricant 7 introduced into the first section 3 and the second section 4, respectively, is the same since it originates from the same source, i.e. the same tank 6, however, it has different properties since its temperature, and thereby its viscosity, is changed before the branched-off lubricant is introduced into the second section 4.

When the first and second sections 3, 4 have been lubricated, the lubricant 7 is led back into the tank 6 via a conduit 14, after which the heat exchanger 9 changes the temperature of the lubricant 7.

Even though the machine 2 in this embodiment is shown with two sections 3, 4, it may comprise a plurality of sections, each having a velocity which is different from the velocities of the other sections, or some of the sections even having the same velocity as other sections.

Furthermore, the lubrication system 5 may comprise temperature sensors (not shown) adapted to measure a temperature of the lubricant fluid, at least at an inlet to one of or all the sections. The temperature sensors (not shown) may be connected to a control unit (not shown) which is adapted to control the heat exchanger 9 to ensure that the temperature of the lubricant fluid has a predetermined level before the lubricant is introduced into a specific section.

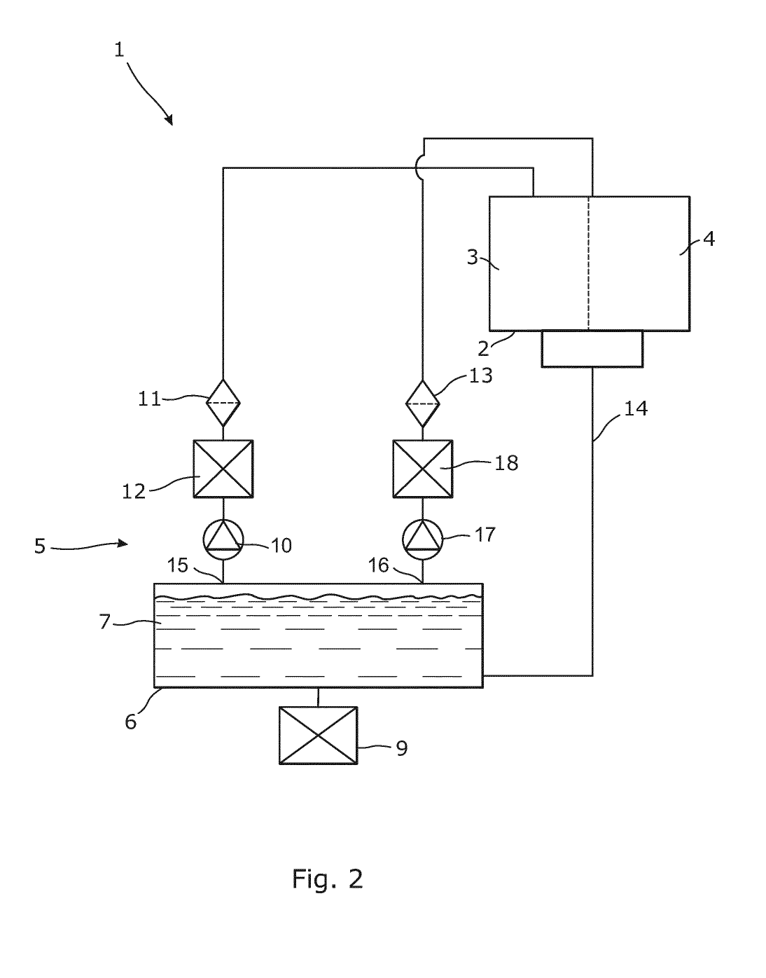

FIG. 2 shows another embodiment of a machine system 1 according to the present invention. In this embodiment, the machine 2 also comprises a first 3 and a second section 4 having different velocities. The lubrication system 5 comprises a tank 6 containing a lubricant 7. As described in connection with FIG. 1, a heat exchanger 9 is arranged in connection with the tank 6.

In this embodiment, the tank 6 has two outlets 15, 16, each outlet being connected to each their pump 10, 17.

The lubricant 7 is led from the tank 6 into an additional heat exchanger 12 via the outlet 15 and the pump 10, in which heat exchanger 12 the temperature of the lubricant 7 is changed. When the lubricant 7 has passed the heat exchanger 12, it is introduced into the first section 3 via a filter 11, having a predetermined temperature and thereby viscosity in view of the velocity of the machine components in the first section 3.

Lubricant 7 is also led from the tank 6 into an additional heat exchanger 18 via the outlet 16 and the pump 17, in which heat exchanger 18 the temperature of the lubricant 7 is changed, not only in relation to the temperature of the lubricant 7 in the tank 6, but preferably also in relation to the temperature of the lubricant 7 introduced into the first section 3. When the lubricant 7 has passed the heat exchanger 18, it is introduced into the second section 4 via a filter 13, having a predetermined temperature and thereby viscosity in view of the velocity of the machine components in the first section 4.

In this embodiment, the pump 10 leading the lubricant 7 to the first section 3 may deliver a first pump pressure and thereby a first flow of the lubricant 7. Similarly, the pump 17 leading the lubricant 7 to the second section 4 may deliver a second pump pressure and thereby a second flow of the lubricant 7. The first and second flows may be different.

As in FIG. 1, the lubricant 7 is led back into the tank 6 via a conduit 14, after which the heat exchanger 9 changes the temperature of the lubricant 7.

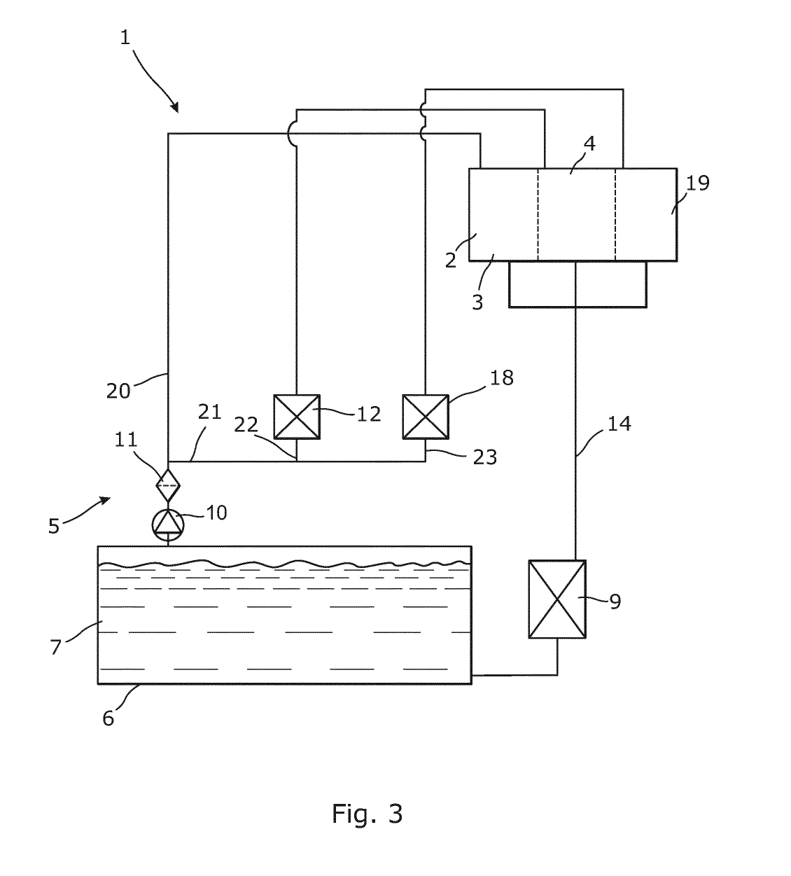

FIG. 3 shows yet another embodiment of the machine system 1 according to the present invention. In this embodiment, the machine 2 comprises a first section 3 having a first velocity, a second section 4 having a second velocity, and a third section 19 having a third velocity. The three velocities are different from each other.

The lubrication system 5 also comprises one tank 6 containing lubricant 7. The lubricant 7 is led to the sections 3, 4, 19 of the machine 2 by the pump 10, and downstream the pump 10, a filter 11 is arranged.

After the filter 11, the conduit branches into two conduits; one conduit 20 leading the lubricant 7 to the first section 3 and another, branched-off conduit 21 being divided into two new conduits 22, 23. The conduit 22 leads the lubricant 7 into the second section 4 via a heat exchanger 12, causing the temperature, and thereby the viscosity of the lubricant 7, to change before the lubricant is introduced into the second section 4. The conduit 23 leads the lubricant 7 into the third section 19 via an additional heat exchanger 18, causing the temperature, and thereby the viscosity of the lubricant 7, to change before the lubricant is introduced into the third section 19.

After lubricating the first, second and third sections 3, 4, 19, the lubricant 7 is led back into the tank 6 via a conduit 14, however, in this embodiment, a heat exchanger 9 arranged in connection with the tank and changes the temperature of the lubricant 7 before the lubricant re-enters the tank 6.

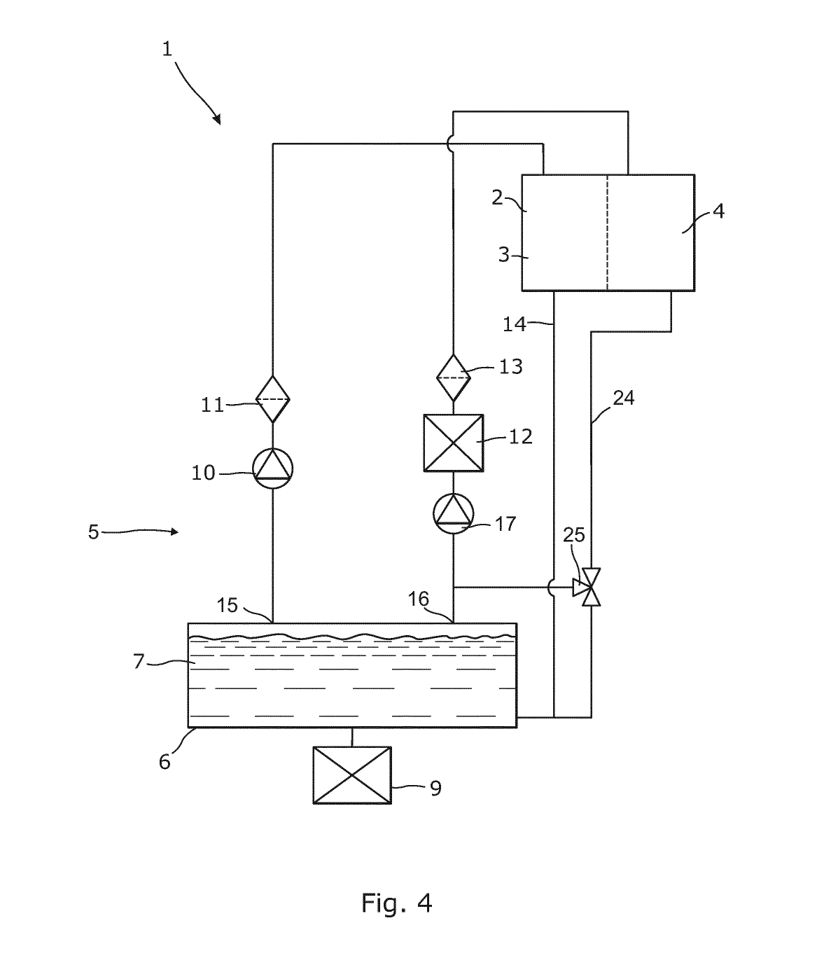

FIG. 4 shows an additional embodiment of the machine system 1 according to the present invention. In this embodiment, the machine 2 again comprises a first section 3 having a first velocity and a second section 4 having a second velocity. The lubrication system 5 comprises a tank 6 containing a lubricant 7. As described in connection with FIGS. 1 and 2, a heat exchanger 9 is arranged in connection with the tank 6.

In this embodiment, the tank 6 has two outlets 15, 16, each outlet being connected to each their pump 10, 17.

The lubricant 7 is led from the tank 6 via into the first section 3 via the outlet 15 and the pump 10. Thus, the temperature of the lubricant 7 introduced into the first section 3 is substantially the same as the temperature of the lubricant in the tank 6. Before the lubricant 7 is introduced into the first section 3, it passed through a filter 11. The pump 10 secures a constant or variable flow of lubricant 7 to the first section 3.

Lubricant 7 is also led from the tank 6 into an additional heat exchanger 12 via the outlet 16 and the pump 17, in which heat exchanger 12 the temperature of the lubricant 7 is changed. When the lubricant 7 has passed the heat exchanger 12, it is introduced into the second section 4 via a filter 13, having a predetermined temperature and thereby viscosity in view of the velocity of the machine components in the first section 4. Indeed, the pump 17 secures a constant or variable flow of lubricant 7 to the second section 4.

In this embodiment, the lubricant 7 leaving the first section 3 may be led directly back into the tank 6 via a conduit 14. Similarly, the lubricant 7 leaving the second section 4 may be led back to the tank 6 via a conduit 24. In this conduit 24, a three-way valve 25 may be arranged, ensuring that the lubricant 7 can be led directly the pump 17 without entering the tank 6 first.

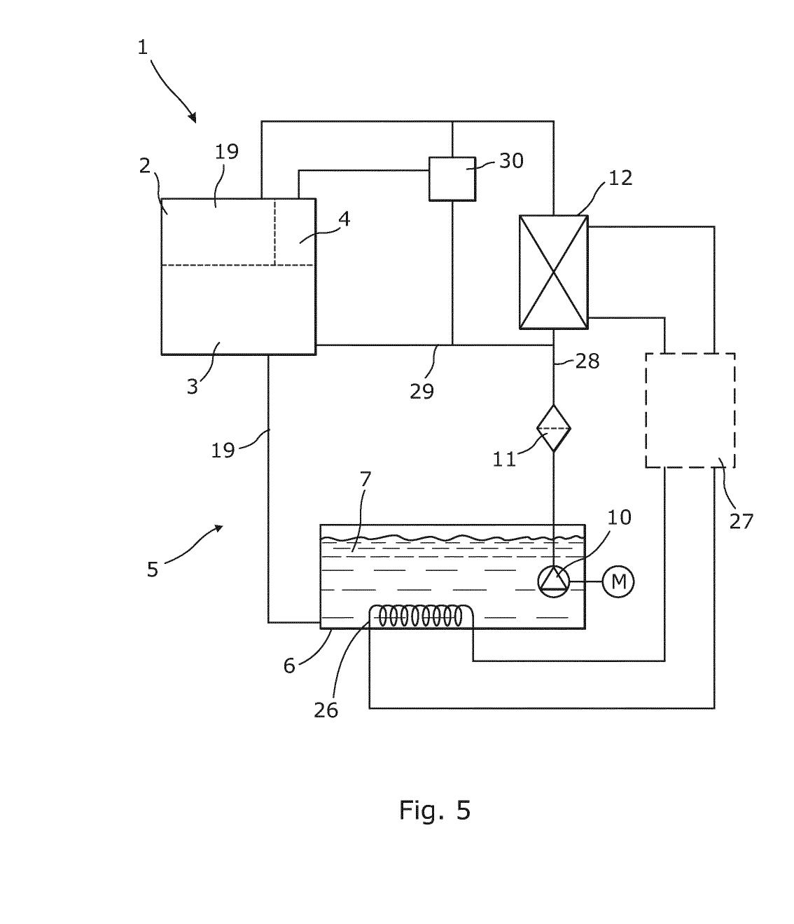

FIG. 5 shows yet another embodiment of the machine system 1 according to the present invention. In this embodiment, the machine 2 comprises a first section 3 having a first velocity, a second section 4 having a second velocity, and a third section 19 having a third velocity. The three velocities are different from each other.

The lubrication system 5 comprises a tank 6 containing a lubricant 7. Inside the tank 6, a coil 26 is arranged for changing the temperature of the lubricant 7 in the tank 6. The coil 26 is connected with a heat transfer system 27 (shown in dotted lines) having a heat transfer medium which is circulated in the coil 26.

Furthermore, a pump 10 is arranged in the tank 6 for leading the lubricant 7 towards the different sections 3, 4, 19. A filter 11 is arranged downstream the pump 10. After the filter 11, a conduit 28 branches into two conduits, the branched-off conduit 29 being connected to the first section 3. Thus, the temperature, i.e. a first temperature, of the lubricant 7 being introduced into the first section 3 is substantially the same as that of the lubricant 7 in the tank 6.

The conduit 28 extends into a heat exchanger 12 which is adapted to change the temperature of the lubricant 7. This lubricant 7 may be introduced into the third section 19, having another temperature, i.e. a second temperature, than that of the lubricant 7 being introduced into the first section 3.

Furthermore, a mixing valve 30 is arranged which may be fed with the lubricant 7 having the first temperature and the lubricant 7 having the second temperature, thereby creating a third temperature of the lubricant 7 downstream the mixing valve 30, the third temperature being between the first and second temperatures. The lubricant 7 having the third temperature is introduced into the second section 4.

When the lubricant 7 has lubricated the different moving parts in the three sections 3, 4, 19 of the machine 2, it is led back to the tank 6 via the conduit 14.

Thus, by controlling the viscosity and/or temperature on a number of different levels, for instance at a tank or reservoir, a primary flow to a set of consumers, a secondary flow to a second set of consumers, a tertiary flow to a third group of consumers, and so on, it is possible to use the same lubricant for many different velocities.

For instance, the tank may have an upper level measured in temperature and a lower level measured in viscosity. Most inlets to the machine systems are primarily used for lubrication purposes and will therefore be controlled on viscosity, both for upper and lower limit. But it could be that one inlet has mainly cooling purposes, why the limits may be temperatures. However, those two drivers may be linked by a relatively simple equation:

KV=10¹⁰^{^{A−B log(T)}}−0.7

where KV is the kinematic viscosity in mm²/s, T the lubricant temperature in K, and A/B constants of the selected lubricant. Depending on what is measured, one can invert the equations (and derive for instance T from a measured KV). Also, it may be considered deriving either KV or T from proxy measurements, say pressure and flow.

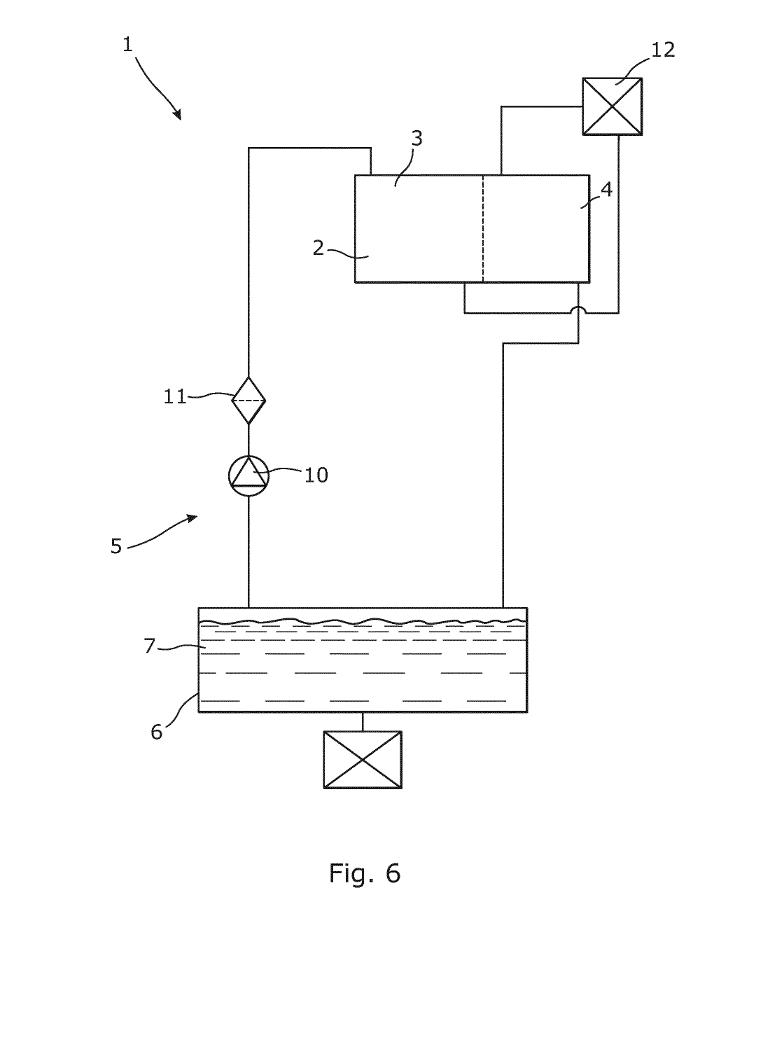

FIG. 6 shows yet another embodiment of the machine system 1 according to the present invention.

The machine 2 has a first section 3 having a first velocity and a second section 4 having a second velocity. The two sections 3, 4 are shown separated by the dotted line.

Furthermore, in connection with the machine system 1, a lubrication system 5 is arranged. In this embodiment, the lubrication system 5 comprises one tank 6 having one lubricant 7.

In connection with the tank 6, a heat exchanger 9 is arranged for chancing the temperature of the lubricant 7 in the tank 6 to a predetermined temperature. Thus, the heat exchanger 9 may cool or heat the lubricant 7 as required.

The lubricant 7 is led from the tank 6 to the machine 2 by means of the pump 10. The pump 10 secures a constant or variable flow of lubricant to the machine 2. Before the lubricant 7 is introduced into the first section 3 of the machine 2, it passes a filter 11 filtering the lubricant 7. Thus, the temperature of the lubricant 7 introduced into the first section 3 is substantially the same as that of the lubricant 7 in the tank 6.

When the lubricant 7 leaves the first section 3, it is led to an additional heat exchanger 12 which changes the temperature of the lubricant 7, after which it is introduced into the second section 4. After lubricating the second section 4, the lubricant 7 is led back into the tank 6.

Advantageously, the machine is a gearbox which has several sections having different velocities, and thus needs lubrication.

Furthermore, the first section 3 and/or the second section 4 may comprise a plurality of stages, each stage having individual stage velocities. The stage velocities within the same section may be substantially identical to or different from each other, however, each stage preferably requires the same viscosity of the lubricant. The sections and/or the stages comprise movable gear parts and/or bearings.

The gearbox may be a gearbox having planetary gear stages, a planetary coupled gearbox or a differential gearbox.

Although the invention has been described in the above in connection with preferred embodiments of the invention, it will be evident for a person skilled in the art that several modifications are conceivable without departing from the invention as defined by the following claims.

1. A machine system comprising:
a machine having at least a first section and a second section, the first section having a first velocity and the second section having a second velocity, the second velocity being different from the first velocity,
a lubrication system comprising at least one tank having one lubricant, the lubrication system being connected to the first and second sections, wherein at least one property of the lubricant is changed before the lubricant is introduced into at least one of the sections.

2. The machine system according to claim 1, wherein the property of the lubricant is a temperature and/or a viscosity.

3. The machine system according to claim 1, wherein the tank comprises a heat exchanger.

4. The machine system according to claim 1, wherein the machine comprises a plurality of sections, each having a velocity which is different from the velocities of the other sections.

5. The machine system according to claim 1, wherein at least one heat exchanger is arranged between the tank and the machine for changing the temperature of the lubricant before it is introduced into a section of the machine.

6. The machine system according to claim 1, wherein a heat transfer system is arranged in connection with each section.

7. The machine system according to claim 1, wherein the lubricant is led back into the tank after having been in a section of the machine.

8. The machine system according to claim 1, wherein the sections of the machine have at least partially fluid-tight separations.

9. The machine system according to claim 1, wherein the temperature of the lubricant present in the tank is maintained above a predetermined level.

10. The machine system according to claim 9, wherein the predetermined level is between 0 degrees Celsius and 70 degrees Celsius, preferably between 0 degrees Celsius and 30 degrees Celsius.

11. The machine system according to claim 1, wherein the temperature of the lubricant introduced into the first section is between 30 degrees Celsius and 50 degrees Celsius.

12. The machine system according to claim 1, wherein the temperature of the lubricant introduced into the second section is between 50 degrees Celsius and 80 degrees Celsius.

13. The machine system according to claim 1, wherein the machine is a gearbox.

14. The machine system according to claim 1, wherein the first section and/or the second section comprise(s) a plurality of stages, each stage having individual stage velocities.

15. The machine system according to claim 14, wherein the stage velocities comprised in the same section may be substantially identical to or different from each other.

16. The machine system according to claim 15, wherein the sections and/or stages comprise movable gear parts and/or bearings.

17. The machine system according to claim 13, wherein the gearbox has planetary gear stages, is a planetary coupled gearbox or is a differential gearbox.

18. The machine system according to claim 1, wherein the lubrication system comprises pressure sensors adapted to measure a pressure of the lubricant, at least at an inlet to the sections.

19. The machine system according to claim 18, wherein the pressure sensors are connected to a control unit which is adapted to control a pump to ensure that a flow, and thereby the pressure, of the lubricant has a predetermined level before the lubricant is introduced into a specific section.

20. The machine system according to claim 1, wherein an inlet flow of lubricant to a first section is different from an inlet flow of lubricant to a second section.

21. The machine system according to claim 1, wherein the lubrication system comprises temperature sensors adapted to measure a temperature of the lubricant, at least at an inlet to the sections.

22. The machine system according to claim 21, wherein the temperature sensors are connected to a control unit which is adapted to control the heat exchanger to ensure that the temperature of the lubricant has a predetermined level before the lubricant is introduced into a specific section.

23. A wind turbine comprising the machine system according to claim 1.

24. The wind turbine according to claim 23, wherein the machine system is a gearbox system.

25. A method for lubricating a machine system, the machine system comprising:
a machine having at least a first section and a second section, the first section having a first velocity and the second section having a second velocity, the second velocity being different from the first velocity,
a lubrication system comprising at least one tank having one lubricant, the lubrication system being connected to the first and second sections, wherein the method comprises the step of changing at least one property of the lubricant before the lubricant is introduced into at least one of the sections.

26. The method according to claim 25, wherein the property of the lubricant is a temperature and/or a viscosity.

27. The method according to claim 25, wherein a temperature of the lubricant is changed before it is introduced into a section of the machine by means of at least one heat exchanger arranged between the tank and the machine.

28. The method according to claim 25, wherein the lubricant is led back into the tank after having been in a section of the machine.

29. The method according to claim 25, wherein the temperature of the lubricant present in the tank is maintained above a predetermined level.

30. The method according to claim 29, wherein the predetermined level is between 0 degrees Celsius and 70 degrees Celsius, preferably between 0 degrees Celsius and 30 degrees Celsius.

31. The method according to claim 25, wherein the temperature/viscosity of the lubricant introduced into the first section is between 30 degrees Celsius and 50 degrees Celsius.

32. The method according to claim 25, wherein the temperature of the lubricant introduced into the second section is between 50 degrees Celsius and 80 degrees Celsius.

33. The method according to claim 25, wherein a pressure of the lubricant is measured by a pressure sensors, at least at an inlet to the sections.

34. The method according to claim 33, wherein the pressure sensors are connected to a control unit which is adapted to control a pump to ensure that a flow, and thereby the pressure, of the lubricant has a predetermined level before the lubricant is introduced into a specific section.

35. The method according to claim 25, wherein an inlet flow of lubricant to a first section is different from an inlet flow of lubricant to a second section.

36. The method according to claim 25, wherein a temperature of the lubricant is measured by temperature sensors, at least at an inlet to the sections.

37. The method according to claim 36, wherein the temperature sensors are connected to a control unit which is adapted to control the heat exchanger to ensure that the temperature of the lubricant has a predetermined level before the lubricant is introduced into a specific section.
